(19) United States
(12) Patent Application Publication
(10) Pub. No.: US 2025/0335891 A1
(43) Pub. Date: Oct. 30, 2025

(54) PROACTIVE ATM MANAGEMENT

(71) Applicant: Wells Fargo Bank, N.A., San Francisco, CA (US)

(72) Inventors: Jonathan Baker, San Francisco, CA (US); Scott Best, San Francisco, CA (US); Frank DiGangi, San Francisco, CA (US); Nicolai J. Lesko, San Francisco, CA (US); Stephen George Mueller, San Francisco, CA (US); Frank C. Rivera, San Francisco, CA (US); Benjamin Taylor, Williston, VT (US); David Winner, San Francisco, CA (US)

(73) Assignee: Wells Fargo Bank, N.A., San Francisco, CA (US)

(21) Appl. No.: 18/651,437

(22) Filed: Apr. 30, 2024

(51) Int. Cl. G06Q 20/10

(52) U.S. Cl. CPC G06Q 20/1085

(57) ABSTRACT

A computing system can include at least one processing circuit that can monitor a first plurality of interactions with a plurality of Automated Teller Machines (ATMs), detect a change from a first status of a first ATM of the plurality of ATMs to a second status of the first ATM, retrieve information corresponding to a second plurality of interactions with the first ATM, identify one or more profiles associated with respective interactions of the second plurality of interactions, determine a plurality of user devices enrolled in a subscription to receive status updates regarding the first ATM, and transmit a signal to the plurality of user devices to cause the plurality of user devices to display a user interface to identify the second status of the first ATM.

### TECHNICAL FIELD

The present disclosure relates to apparatuses, systems, and methods for providing proactive management of transaction devices, such as automated teller machines (ATMs).

### BACKGROUND

ATMs are a convenient way for customers (e.g., cardholders of a financial institution) to complete financial transactions, including document deposits, banknote deposits and the like. ATMs may be placed and accessed by customers at various geographic locations, such as bank locations, convenience stores, other stores, or standalone kiosks to facilitate a customer's interaction with the banking systems.

### SUMMARY OF THE DISCLOSURE

One embodiment of the disclosure relates to a computing system including at least one processing circuit having at least one processor coupled to at least one memory device. The at least one memory device can store instructions that, when executed by the at least one processing circuit, cause the at least one processing circuit to monitor, based on communications with a plurality of Automated Teller Machines (ATMs), a first plurality of interactions with the plurality of ATMs. The instructions can also cause the at least one processing circuit to detect, subsequent to monitoring the first plurality of interactions with the plurality of ATMs, a change from a first status of a first ATM of the plurality of ATMs to a second status of the first ATM. The instructions can also cause the at least one processing circuit to retrieve, from a database, responsive to detection of the change from the first status to the second status, information corresponding to a second plurality of interactions with the first ATM. The instructions can also cause the at least one processing circuit to identify, responsive to retrieval of the information, one or more profiles associated with respective interactions of the second plurality of interactions. The instructions can also cause the at least one processing circuit to determine, based at least one the one or more profiles, a plurality of user devices enrolled in a subscription to receive status updates regarding the first ATM. The instructions can also cause the at least one processing circuit to transmit, responsive to determination of the plurality of user devices, a signal to the plurality of user devices to cause the plurality of user devices to display a user interface to identify the second status of the first ATM.

Another embodiment of the present disclosure relates to a method. The method can include monitoring, by a computing system based on communications with a plurality of Automated Teller Machines (ATMs), a first plurality of interactions with the plurality of ATMs. The method can also include detecting, by the computing system subsequent to monitoring the first plurality of interactions with the plurality of ATMs, a change from a first status of a first ATM of the plurality of ATMs to a second status of the first ATM. The method can also include retrieving, by the computing system from a database, responsive to detecting the change from the first status to the second status, information corresponding to a second plurality of interactions with the first ATM. The method can also include identifying, by the computing system responsive to retrieval of the information, one or more profiles associated with respective interactions of the second plurality of interactions. The method can also include determining, by the computing system based at least one the one or more profiles, a plurality of user devices enrolled in a subscription to receive status updates regarding the first ATM. The method can also include transmitting, by the computing system responsive to determination of the plurality of user devices, a signal to the plurality of user devices to cause the plurality of user devices to display a user interface to identify the second status of the first ATM.

Still another embodiment relates to a non-transitory computer-readable storage media having instructions stored thereon that, when executed by at least one processor of a provider computing system, cause the provider computing system to perform operations including: monitoring, based on communications with a plurality of Automated Teller Machines (ATMs), a first plurality of interactions with the plurality of ATMs; detecting, subsequent to monitoring the first plurality of interactions with the plurality of ATMs, a change from a first status of a first ATM of the plurality of ATMs to a second status of the first ATM; retrieving, from a database, responsive to detection of the change from the first status to the second status, information corresponding to a second plurality of interactions with the first ATM; identifying, responsive to retrieval of the information, one or more profiles associated with respective interactions of the second plurality of interactions; determining, based at least one the one or more profiles, a plurality of user devices enrolled in a subscription to receive status updates regarding the first ATM; and transmitting, responsive to determination of the plurality of user devices, a signal to the plurality of user devices to cause the plurality of user devices to display a user interface to identify the second status of the first ATM.

### BRIEF DESCRIPTION OF THE DRAWINGS

FIG. 1 is a block diagram of a transaction computing system, according to an example embodiment.

FIG. 2 is a is a block diagram of an ATM system, according to an example embodiment.

FIG. 3 is a front elevated view of the ATM system of FIG. 2, according to an example embodiment.

FIG. 4 is a front lower view of the ATM of FIG. 2 with certain internal zones shown within dashed boxes, according to an example arrangement.

FIG. 5 is a block diagram of a system for proactive ATM management, according to an example embodiment.

FIG. 6 is an illustration of a user interface including an indication of authentication methods available at a given ATM, according to an example embodiment.

FIG. 7 is an illustration of a user interface including ATM's overlayed on a map, according to an example embodiment.

FIG. 8 is flow diagram of a method to provide proactive ATM management, according to an example embodiment.

### DETAILED DESCRIPTION

Aspects of this technical solution are described herein with reference to the figures, which are illustrative examples of this technical solution. The figures and examples below are not meant to limit the scope of this technical solution to the present implementations or to a single implementation, and other implementations in accordance with present implementations are possible, for example, by way of interchange of some or all of the described or illustrated elements. Where certain elements of the present implementations can be partially or fully implemented using known components, only those portions of such known components that are necessary for an understanding of the present implementations are described, and detailed descriptions of other portions of such known components are omitted to not obscure the present implementations. Terms in the specification and claims are to be ascribed no uncommon or special meaning unless explicitly set forth herein.

The systems, methods, computer-readable media, and apparatuses described herein relate to proactive ATM management for one or more ATMs, and particularly providing user notification as to the status of the one or more ATMs to improve the user experience while interacting with the ATMs. According to various embodiments described herein, the systems, methods, and computer-readable media described herein relate to a technical solution of detecting changes in status of one or more ATMs and proactively alerting one or more users to assist with locating one or more subsequent ATMs. Advantageously, a user may be alerted as to the status of a given ATM without the user having to first visit the ATM. For example, a user may subscribe and/or enroll in a subscription to receive status updates for given ATMs, such as ATMs frequently visited by the user. To continue this example, a computer system may detect a change in status for a given ATM and the computer system may then alert (e.g., proactively manage the given ATM) the user, enrolled in status updates, as to the updated status of the given ATM.

The systems, methods, and computer-readable media described herein provide and describe various technical improvements to existing management systems. For example, by providing a user with the ability to enroll in subscriptions, the user may select which ATMs they would like to receive status updates for. As another example, the computer system may proactively assist the user in finding a different ATM without the user having to first ask for assistance (e.g., the computer system automatically identifies subsequent ATMs based on a change in status for a given ATM). In this way, the computer system may proactively prevent wasted time as the computer system alerts user of a status change for an ATM prior to the user visiting the ATM.

Additionally, the technical improvements over existing systems include the computer system diverting users from downed (e.g., malfunctioned, experiencing faults, lagging, etc.) ATMs to one or more operating ATMs. Moreover, the computer system can distribute workload across multiple ATMs to reduce and/or adjust interactions with high traffic ATMs. For example, the computer system can divert traffic, from a busy ATM, to one or more idle ATMs to reduce both a number of interactions with the busy ATM and an amount of time to complete interactions (e.g., wait time). The computer system diverting traffic can decrease the likelihood and/or the frequency of downtime for a given ATM. The computer system proactively alerting users about downed ATMs can also decrease bandwidth usage regarding communication sessions with a downed ATM (e.g., reduce communications with an ATM while the ATM downed).

As used herein, an interaction may refer to a user transacting and/or interfacing with one or more ATMs. For example, a user withdrawing resources from a given ATM may refer to and/or include an interaction with the given ATM. As another example, a user storing an item within a vault of the ATM may refer to and/or include an interaction with the ATM. As even another example, a user providing information to a given ATM may refer to and/or include an interaction with the ATM. Additional examples of interactions with one or more ATMs are described herein.

Current ATM systems do not offer specialized functionalities directed to non-customers that provide the non-customers with a service or associated benefit by utilizing the ATM. The widespread availability of ATM systems and their ability to communicate with financial institution computer systems, third-party computer systems, and the like, makes ATM systems an easily accessible medium capable of providing services beyond traditional financial transactions to both customers of a financial institution and non-customers. Accordingly, the present disclosure relates to ATM systems capable of performing expanded functionalities that benefit both customers of the financial institution associated with the ATM and non-customers of the financial institution. For example, and as discussed herein, ATM systems may operate as a storage repository for non-monetary items, may host specialized banking channels accessible to non-customers (e.g., non-cardholders) of the financial institution, may allow customers and non-customers to donate funds to third-party (e.g., charitable) accounts, or may allow non-customers to conduct transactions with third parties (e.g., cash checks drawn on a financial institution not associated with the ATM) via the ATM interface.

The ATMs including a non-monetary storage repository disclosed herein may enable one or more ATM transactions which may include, but are not limited to, temporary storage of non-monetary media for safekeeping, rental of non-monetary media from the ATM for a designated time period, exchange of non-monetary media into the ATM storage repository for currency, exchange of currency into the ATM monetary repository for non-monetary media, and so on. Beneficially, the transaction devices (e.g., the ATM) disclosed herein include improved graphical user interfaces which allow limited access to the secure area of the ATM vault. The increased access to the ATM vault provides more security for the storage of personal items, allows secure transfers of valuable items, and/or permits the convenient trade-in or sale of non-monetary items via readily available ATM terminals. Further, the ATM devices disclosed herein provide increased financial flexibility to non-customers through non-customer banking channels hosted or otherwise associated with the ATM. Non-customer banking channels enable individuals without an existing account to access certain banking services and store their funds in the secure ATM environment behind additional layers of authentication and protection otherwise unavailable to non-account holders. Additionally, the non-customer may convert their non-customer banking channel into a formal customer account, such as a checking account, deposit account, savings account, or similar. This conversion process allows the non-customer to transition seamlessly to a more comprehensive banking relationship with the provider institution, allowing the non-customer access to a broader range of financial services and benefits.

As utilized herein, a “customer” may refer to an individual, business, entity, etc. that has registered as an account holder with the financial institution associated with the ATM, is a cardholder of the financial institution associated with the ATM, or the like. For example, a “customer” of Bank A has an established a relationship with Bank A by opening an account and utilizing the various financial services offered by Bank A. A “customer” includes an individual who has registered via Bank A's website and has opened a checking and/or savings account with Bank A. Additionally, a “customer” of Bank A includes an individual who is a cardholder of Bank A and may utilize the ATMs of Bank A by inserting their card, entering a PIN/passcode, ctc. A “non-customer” may refer to an individual, business, entity, etc. that has not registered as a checking/savings account holder with the financial institution associated with the ATM, is not a cardholder of the financial institution associated with the ATM, or the like. A “non-customer” does not have access to the various services offered by the bank beyond basic public services or may only have access to services encumbered by non-customer restrictions (e.g., transaction limits, geographical limitations, additional fees, etc.). For example, a “non-customer” of Bank A includes an individual who is registered with and owns a checking/savings account with Bank B and not Bank A, an individual who is not a cardholder of Bank A, an individual who transacts with Bank A on a limited basis (e.g., via a non-customer banking channel of an ATM as disclosed herein) and the like.

Also, as used herein, a “non-customer banking channel” may refer to a financial account offered by a provider institution that allows individuals and/or entities who are not existing customers of the provider institution to create a banking channel resembling a checking or deposit type account. The non-customer (or a customer that wishes to have both a customer account as well as a non-customer banking channel which may include restrictions unique to the non-customer banking channel) may create or otherwise establish the non-customer banking channel by providing non-customer account data (e.g., at an ATM). For example, a parent may be a customer of a provider institution and wish to create a non-customer account for a child, the non-customer account accessible via an ATM located at or near the child's school.

The non-customer banking channel may be hosted on the ATM or associated with a particular ATM. For example, the non-customer banking channel may only be accessible via the ATM on which it was created or via a limited number of ATMs (such as ATMs at designated geographical locations). In this way, the non-customer banking channel may be provided on a specific ATM or tied to a particular group of ATMs. Further, the non-customer banking channel may store funds (e.g., a non-customer account balance) up to a non-customer account limit. The non-customer account limit may be a predetermined limit set by the provider institution or selected by the account creator. The ATM and/or the provider institution may charge fees associated with using the non-customer banking channel (e.g., fees associated with depositing to or withdrawing funds from the non-customer banking channel). Additionally, the non-customer banking channel may be converted to a customer account, such as a checking account, a deposit account, a savings account, or the like, by selecting a prompt, signing up, or otherwise registering with the provider institution (e.g., via the ATM, via a website of the provider institution, etc.).

Further, as used herein, “non-monetary media” may refer to various non-monetary items that hold value or serve a functional purpose beyond their monetary equivalent. For example, non-monetary media may include phones, watches, jewelry, handbags, apparel, and the like. Non-monetary media may also refer to documents, letters, passports, tickets, coupons, etc.

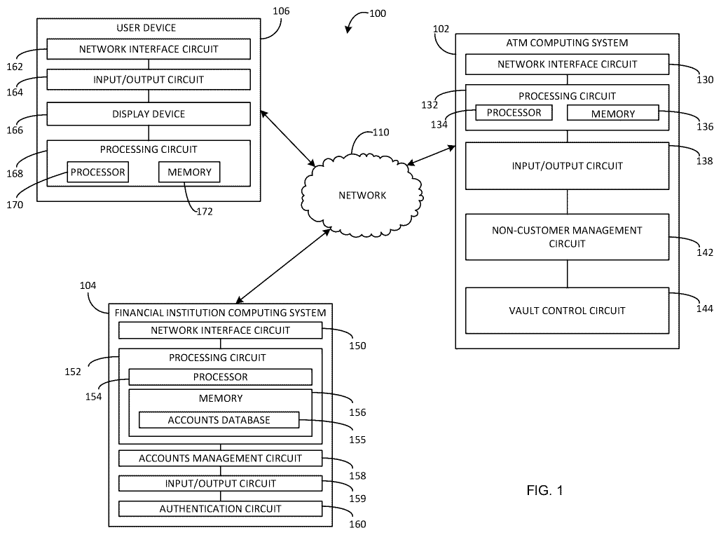

Referring to FIG. 1, a system 100 for enabling ATM transactions for a customer and/or non-customer is shown, according to an example embodiment. The system 100 includes an ATM computing system 102 and a financial institution computing system 104. In some embodiments, the system 100 may include a user device 106. The systems, devices, and/or components of the system 100 may be configured to communicate with each other over a network 110. The network 110 may include one or more of the Internet, cellular network, Wi-Fi®, Wi-Max, a proprietary banking network, or any other type of wired, wireless, or a combination of wired and wireless networks.

The ATM computing system 102 may be or include an ATM computing system. In some embodiments, the ATM computing system 102 includes a network interface circuit 130 that is configured to provide an interface between a user device (e.g., user device 106 of the customer, the non-customer) and the financial institution computing system 104 over the network 110. The ATM computing system 102 is configured to enable various ATM transactions for a customer of the financial institution, such as allowing the customer to view account balances, purchase stamps, deposit checks, transfer funds, withdraw funds from a given account in the form of cash or other physical currency, and so on. For example, the ATM computing system 102 can include an ATM card slot configured to receive an ATM card inserted by a customer. The ATM computing system 102 may include a currency dispenser that is used to dispense currency when a user performs a physical currency withdrawal. In some embodiments, the ATM computing system 102 is disposed at a brick-and-mortar banking facility associated with the provider/associated financial institution. In other embodiments, the ATM computing system 102 is a standalone computing terminal (e.g., disposed at an unrelated retail facility, within an office building, etc.).

In addition to customer transactions, the ATM computing system 102 may be configured to enable various expanded functionalities for customers, non-customers, or both customers and non-customers (e.g., any user of the ATM). For example, the ATM computing system 102 may provide non-monetary storage services for customers and non-customers of the financial institution. The ATM computing system 102 may include a media aperture that is configured to receive non-monetary media, physical items, and the like, such as keys, mobile phones, jewelry, apparel/accessories, etc. In this way, the ATM computing system 102 may temporarily serve as a secure storage repository for non-monetary media until retrieved by the customer or the non-customer. In other embodiments, the ATM computing system 102 may allow customers and non-customers to deposit non-monetary media into the storage repository in exchange for paper currency or other monetary items (e.g., trade in an old cell phone, electronic device, etc. in exchange for physical currency, account credits, or the like). In still further embodiments, the ATM computing system 102 may be configured to allow customers and non-customers to lease, rent, or temporarily receive non-monetary media from the storage repository (e.g., rent hotel/vehicle keys for temporary use until returned to the ATM, receive/return access cards, keycards, and the like, etc.). As another example, the ATM computing system 102 may be configured to allow customers and non-customers to donate funds into accounts associated with third parties (e.g., serve as “donation/deposit boxes” through which customers and non-customers can provide funds for charitable organizations, fundraisers, and the like).

The ATM computing system 102 may also be configured to provide expanded functionalities directed to non-customers, such as allowing non-customers to cash checks drawn on a third-party institution or allowing non-customers to utilize a limited banking channel operated by the provider institution and hosted, enabled, or otherwise associated with at least one specific ATM.

In the example shown, the ATM computing system 102 includes a network interface circuit 130, a processing circuit 132, an input/output circuit 138, a non-customer management circuit 142, and a vault control circuit 144.

The network interface circuit 130 is configured or structured to establish connections via the network 110 between the ATM computing system 102 and the financial institution computing system 104 and/or the user device 106. In some embodiments the network interface circuit 130 may be configured to establish communications via the network 110 with a third-party computing system, such as a computer system of a third-party financial institution that is not a provider of the ATM, a computer system of a credit union, a computer system of a non-bank financial institution, etc. Thus, in this embodiment, the ATM is a network-connected ATM.

The processing circuit 132 includes at least one processor 134 and at least one memory 136. The memory 136 is structured to retrievably store information regarding accounts held by various users. The accounts may include a checking account held by the customer and accessible via the user device 106, a non-customer banking channel associated with the ATM, accounts of charities/organizations configured to receive deposits in the form of donations from ATM users, or other suitable accounts. For instance, the memory 136 may store information related to the financial account of the user, such as authentication information (e.g., username/password combinations, personal identification numbers (PINs), device authentication tokens, security question answers, account information, balances, biometric data, etc.). Furthermore, the memory 136 may store any other information that may be encountered in the operation of an ATM with expanded functionalities for customers and non-customers or otherwise referenced herein, such as user preferences and other information comprising a user profile, transaction history, etc. The processing circuit 132 may perform or assist in performing any of the operations, steps, or methods discussed herein. While the ATM computing system 102 is shown to include the memory 136, the memory 136 may include remote storage, multiple memory systems storing separate data, and/or multiple memory systems storing separate information.

In some embodiments, the network interface circuit 130 may include one or more antennas or transceivers and associated communications hardware and logic (e.g., computer code, instructions, etc.). The network interface circuit 130 may also include program logic that is structured to allow the ATM computing system 102 to access and couple/connect to the network 110 to, in turn, exchange information with for example the financial institution computing system 104, the user device 106, a third-party computing systems, and/or other ATM systems (and potentially other systems/devices). That is, the network interface circuit 130 is coupled to the processor 134 and memory 136 and configured to enable a coupling to the network 110. The network interface circuit 130 allows for the ATM computing system 102 to transmit and receive data over the network 110. Accordingly, the network interface circuit 130 includes any one or more of a cellular transceiver, a wireless network transceiver, and a combination thereof. Thus, the network interface circuit 130 enables connectivity to wide area networks (WANs) as well as local area networks (LANs). Further, in some embodiments, the network interface circuit 130 includes cryptography capabilities to establish a secure or relatively secure communication session between other systems such as the financial institution computing system 104, a second ATM system, the user device 106, etc. In this regard, information (e.g., account information, login information, financial data, digital objects, and/or other types of data) may be encrypted and transmitted to prevent or substantially prevent a threat of hacking or other security breach.

The input/output circuit 138 is structured to receive communications from and provide communications to other computing devices, users, and the like associated with the ATM computing system 102. The input/output circuit 138 is structured to exchange data, communications, instructions, and the like with an input/output device of the components of the system 100. In some arrangements, the input/output circuit 138 includes communication circuitry for facilitating the exchange of data, values, messages, and the like between the input/output circuit 138 and the components of the ATM computing system 102. In some arrangements, the input/output circuit 138 includes machine-readable media for facilitating the exchange of information between the input/output circuit 138 and the components of the financial institution computing system 104, the user device 106, and/or a third-party computing system. In some arrangements, the input/output circuit 138 includes any combination of hardware components, communication circuitry, and machine-readable media.

In some arrangements, the I/O circuit 138 includes suitable input/output ports and/or uses an interconnect bus for interconnection with a local display (e.g., a liquid crystal display, a touchscreen display) and/or keyboard/mouse devices (when applicable), or the like, serving as a local user interface for programming and/or data entry, retrieval, or other user interaction purposes. As such, the input/output circuit 138 may provide an interface for the user to interact with various applications and/or executables stored, hosted, or otherwise provided on the ATM computing system 102 and/or the financial institution computing system 104. For example, the input/output circuit 138 may include a keyboard, a keypad, a mouse, joystick, a touch screen, a microphone, a biometric device, a virtual reality headset, smart glasses, and the like. As another example, input/output circuit 138, may include, but is not limited to, a television monitor, a computer monitor, a printer, a facsimile, a speaker, and so on.

The non-customer management circuit 142 is structured to manage, operate, and otherwise enable transactions and functionalities directed to non-customers of the provider institution associated with the ATM. In this way, the non-customer management circuit 142 enables the ATM to provide certain banking services to individuals who do not hold traditional accounts (e.g., checking accounts, savings accounts, etc.) with the bank associated with the ATM. The non-customer management circuit 142 may store information indicative of non-customer banking channels hosted and/or accessible via the ATM. For example, the non-customer management circuit 142 may receive user data from non-customers via an input device of the ATM and send the user data to the processing circuit 132 and/or the financial institution computing system 104 in order to create a banking channel associated with a non-customer, perform transactions associated with a non-customer banking channel, receive deposits from non-customers directed to third-party accounts, and/or cash checks of non-customers drawn on a third-party institution.

The non-customer management circuit 142 may identify and authenticate non-customers of the bank by providing temporary access codes, one-time-use tokens, or other authentication credentials to the non-customers to ensure the security of transactions. The non-customer management circuit 142 may also enable the ATM to open a banking channel for a non-customer. The non-customer banking channel may allow the non-customer to perform certain transactions, such as cash withdrawals, balance inquiries, or other limited banking services. The limited banking services may be subject to non-customer restrictions such as deposit/withdrawal caps, additional fees for processing transactions, geographic limitations of service, and the like. In some embodiments, the non-customer banking channel may only be accessible on one or more designated ATMs. Additionally, the non-customer management circuit 142 may facilitate check cashing for non-customers, including cashing checks drawn on third party institutions. In this way, the non-customer management circuit 142 may communicate with the financial institution computing system 104 and/or a third-party institution computing system to verify the authenticity of the check, confirm the identity of the individual presenting the check, and dispense the appropriate amount of currency.

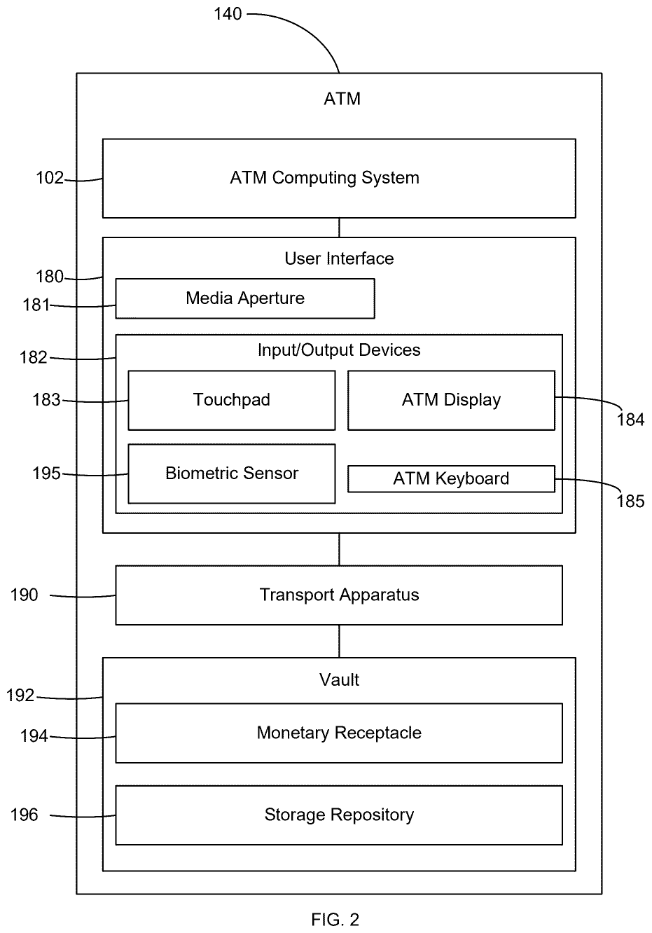

Referring to FIG. 1 and FIG. 2, the vault control circuit 144 is configured to manage the security, access, and operation of a vault 192 of the ATM. The vault may be or include a secure compartment within the ATM that may house physical currency, active/inactive transaction cards, other monetary items, and/or non-monetary media. As shown in FIG. 2, the vault 192 may include a monetary receptacle 194 for storing physical currency and other monetary items. Similarly, the vault 192 may include a storage repository 196 configured to securely receive, provide, and/or store non-monetary media such as keys, phones, jewelry, and the like. The vault control circuit 144 may facilitate/provide access to and from the vault 192 by customers, non-customers, and/or technicians/providers of the ATM. The vault control circuit 144 may receive passcodes, commands, or other inputs, or otherwise be configured to allow a technician to access the vault 192 (e.g., to re-supply the ATM with physical currency) and/or may regulate customer and non-customer access to items or currency stored in the vault 192. For example, the vault control circuit 144 may operate, command, or otherwise control at least one transport apparatus 190 that may selectively deposit or withdraw currency and/or non-monetary media from the vault 192 during a transaction at the ATM. In some embodiments, the vault control circuit 144 may monitor the status/identify of the contents of the vault 192 and provide information regarding the vault 192 to the processing circuit 132 and/or the financial institution computing system 104. For example, the vault control circuit 144 may track an amount of funds present in the monetary receptacle 194, an occupied/unoccupied status of the storage repository 196, an identity of non-monetary media stored in the ATM, and/or a percentage of available storage space within the vault 192, among other information.

Referring back to FIG. 1, the financial institution computing system 104 may be or include a computing system associated with an entity or provider institution, such as a financial institution, capable of maintaining user accounts (e.g., ATM card accounts, non-customer banking channels, etc.) and databases of user information. In the example shown, the provider institution is a financial institution. The financial institution may include commercial or private banks, credit unions, investment brokerages, or other financial institutions. The financial institution computing system 104 may maintain a plurality of user accounts having various information. In the example shown, the provider institution is an issuer of ATM cards (e.g., a debit card) for customers of the financial institution to use at the ATM. Additionally, the provider institution, via the system 100 and ATM computing system 102, provides functionalities for non-customers at the ATM as discussed herein. For example, the provider institution provides non-customer banking channels hosted/associated with one or more specific ATMs. Additionally, the provider institution provides access to ATM storage repositories for non-currency physical media, provision of transactions (e.g., donations) to third parties without requiring a user to have an account at the financial institution, etc.

Also, in the example shown, the financial institution computing system 104 is structured as a backend computing system that may comprise one or more servers. The financial institution may provide or support the ATM computing system 102 (e.g., manufacture or cause manufacturing of the ATM computing system 102 and ATM(s), facilitate access to accounts maintained by the financial institution computing system 104 via the ATM computing system 102, etc.). In some embodiments, the financial institution computing system 104 is structured to permit, facilitate, manage, process, and allow ATM transactions via communication with the user device 106 and/or the ATM computing system 102. The financial institution computing system 104 may store information relating to a user account, as it may be used to execute an ATM transaction via the ATM computing system 102. For example, the financial institution computing system 104 may store information relating to checking accounts, savings accounts, withdrawals of funds, deposits of funds, non-customer banking channels, storage/exchanges of non-monetary media, and so on. In this way, the financial institution computing system 104 may store or receive information from the non-customer management circuit 142 of the ATM relating to non-customer use of the ATM computing system 102. Examples of information relating to non-customer use of the ATM computing system 102 include non-customer banking channels hosted, supported, or maintained on the financial institution computing system 104 and/or the ATM computing system 102, data/access codes/identifiers associated with non-monetary physical media stored within an ATM or exchanged at an ATM for currency, and the like. As will be appreciated, the level of functionality that resides on the financial institution computing system 104 as opposed to the ATM computing system 102 may vary depending on the implementation of this disclosure. As shown, the financial institution computing system 104 includes a network interface circuit 150, a processing circuit 152, an accounts database 155, an accounts management circuit 158, an input/output circuit 159, and an authentication circuit 160.

The network interface circuit 150 is structured to couple to the network 110 to enable communications with the user device 106 and/or the ATM computing system 102, among potentially other systems and devices. In some embodiments, the network interface circuit 150 includes programming and/or hardware-based components that connect the financial institution computing system 104 to the network 110. The network interface circuit 150 may be coupled to the processing circuit 152 to enable the processing circuit 152 to receive and transmit messages, data, and information via the network 110. In some embodiments, the network interface circuit 150 may include one or more antennas or transceivers and associated communications hardware and logic (e.g., computer code, instructions, etc.). The network interface circuit 150 may also include program logic that is structured to allow the financial institution computing system 104 to access and couple/connect to the network 110 to, in turn, exchange information with for example the user device 106 and/or the ATM computing system 102 (and potentially other systems/devices). The network interface circuit 150 allows for the financial institution computing system 104 to transmit and receive data over the network 110. Accordingly, the network interface circuit 150 includes any one or more of a cellular transceiver (e.g., CDMA, GSM, LTE, etc.), a wireless network transceiver (e.g., 802.11X, ZigBee, WI-FI, Internet, etc.), and a combination thereof (e.g., both a cellular transceiver and a wireless transceiver). Thus, the network interface circuit 150 enables connectivity to WAN as well as LAN (e.g., Bluetooth, near field communication (NFC), etc. transceivers). Further, in some embodiments, the network interface circuit 150 includes cryptography capabilities to establish a secure or relatively secure communication session between other systems such as the user device 106, the ATM computing system 102, etc. In this regard, information (e.g., account information, login information, financial data, digital objects, and/or other types of data) may be encrypted and transmitted to prevent or substantially prevent a threat of hacking or other security breach. To further support features of or interaction with the financial institution computing system 104, the network interface circuit 150 may provide a relatively high-speed link to the network 110.

The at least one processing circuit 152 is shown to include at least one processor 154 and at least one memory 156 and may be communicably connected to the network interface circuit 150, the accounts management circuit 158, the input/output circuit 159, and the authentication circuit 160. The memory 156 includes one or more memory devices (e.g., RAM, NVRAM, ROM, Flash Memory, hard disk storage) that store data and/or computer code for facilitating the various processes described herein. That is, in operation and use, the memory 156 stores at least portions of instructions and data for execution by the processor 154 to perform various operations. The memory 156 may be or include tangible, non-transient volatile memory and/or non-volatile memory. The processor 154 may be implemented as one or more processors, application specific integrated circuits (ASIC), one or more field programmable gate arrays (FPGAs), a digital signal processor (DSP), a group of processing components, or other suitable electronic processing components. The processing circuit 152 may perform or assist in performing any of the operations, steps, or methods discussed herein.

The financial institution computing system 104 may include, maintain, or otherwise access an accounts database 155. The accounts database 155 is structured to retrievably store information regarding accounts held by customers and non-customers of the provider institution. For example, the accounts database 155 may store information regarding a debit account held by a customer of the financial institution. The accounts database 155 may also store information regarding a banking channel associated with a non-customer of the financial institution and provided via the ATM computing system 102 and/or the user device 106. For instance, the accounts database 155 may store information related to the user, the user device 106, and/or the ATM computing system 102 such as authentication information (e.g., username/password combinations, device authentication tokens, security question answers, OTPs, PINs, biometric information, etc.), user information (e.g., name, date of birth, etc.), account information (e.g., account number, balance information, expiration date, etc.), banking channel information (e.g., quantity of funds deposited, banking channel balance limit, ATMs permitted to access/host the banking channel, etc.), identifiers of ATM storage repositories that are occupied/unoccupied, logs of items received via ATM storage repositories in exchange for currency, and so on. The accounts database 155 may store within the user's client account all or mostly all of the items that the user has registered with the financial institution computing system 104, including customer and/or non-customer data (such as user profiles with customer/non-customer personal information, account/banking channel numbers, bill and payment histories, communications sent and received from the customer/non-customer, etc.). In various embodiments, the accounts database 155 is structured as one or more remote data-storage facilities (e.g., cloud servers). In some embodiments, the accounts database 155 may be located in whole or in part on the ATM computing system 102.

The accounts management circuit 158 is structured to manage the financial accounts and banking channels of various users, including maintaining and handling transaction processing for one or more financial accounts or banking channels of the users. Accordingly, the accounts management circuit 158 is configured to process payments made from an account of the user held at the financial institution associated with the financial institution computing system 104. Further, the accounts management circuit 158 is configured to process deposits/withdrawals that a non-customer makes into/from the non-customer's banking channel via the ATM computing system 102 and/or the user device 106. In some embodiments, the accounts management circuit 158 is further configured to interface with the ATM non-customer management circuit 142 such that the accounts management circuit 158 provides interfaces, displays, and associated content to enable non-customers to manage banking channels provided via the ATM computing system 102 associated with the financial institution computing system 104. In further embodiments, the accounts management circuit 158 is further configured to interface with ATM vault control circuit 144 such that the accounts management circuit 158 provides interfaces, displays, and associated content to enable customers and/or non-customers to store/retrieve non-monetary physical media within an ATM or exchange/receive non-monetary media at the ATM for currency, account credits, or the like. In still further embodiments, the accounts management circuit 158 is configured to manage financial accounts of entities, individuals, organizations, charities, or other suitable parties that may receive deposits from customers and/or non-customers (e.g., donations) at one or more designated ATMs, one or more ATMs within a designated geographic region, etc.

Like the input/output circuit 138, the input/output circuit 159 is structured to receive communications from and provide communications to other computing devices, users, and the like associated with the financial institution computing system 104. The input/output circuit 159 is structured to exchange data, communications, instructions, and the like with an input/output device of the components of the system 100. In some arrangements, the input/output circuit 159 includes any combination of hardware components, communication circuitry, and machine-readable media for facilitating the exchange of data, values, messages, and the like between the input/output circuit 159 and the components of the financial institution computing system 104 and/or the system 100.

In some arrangements, the I/O circuit 159 includes suitable input/output ports and/or uses an interconnect bus for interconnection with a local display (e.g., a liquid crystal display, a touchscreen display) and/or keyboard/mouse devices (when applicable), or the like, serving as a local user interface for programming and/or data entry, retrieval, or other user interaction purposes. As such, the input/output circuit 159 may provide an interface for the user to interact with various applications and/or executables stored on the financial institution computing system 104.

The authentication circuit 160 is configured to verify that users attempting to access the ATM to perform transactions are legitimate account holders or are legitimate non-customers associated with banking channels of the ATM. In this way, the authentication circuit 160 is configured to prevent unauthorized access to customer accounts (e.g., checking accounts, saving accounts, etc.) and non-customer accounts (e.g., non-customer banking channels). The authentication circuit 160 may receive input data from the ATM, such as account numbers, account identifiers, username and password combinations, passcodes, biometric data and the like related to the identity of the ATM user. The authentication circuit 160 may compare data received from an ATM user with user information stored in the accounts database 155 of the financial institution computing system 104. The authentication circuit 160 may also permit access to specific ATM functionalities based on respective user account data, privileges, and status as a customer/non-customer. For example, the authentication circuit 160 may permit a customer to withdraw cash, check an account balance, or perform other authorized transactions and may direct a non-customer to open a non-customer banking channel or access an already existing non-customer banking channel. The authentication circuit 160 may also store or track information about user access, authentication attempts, and transaction details associated with one or more ATMs (e.g., whether a user attempts to access a non-customer banking channel associated with a designated ATM at an undesignated ATM, etc.). Additionally, the authentication circuit 160 may obtain information from various sources (e.g., by sending a text to the user device 106 with a verification code, by receiving inputs from the ATM, etc.) to authenticate a new user of the ATM computing system 102.

The authentication circuit 160 may also generate, send, and/or verify authentication credentials associated with transactions involving non-monetary media at one or more ATMs. For example, a user may deposit a non-monetary item for storage in the storage repository 196 of the ATM. The authentication circuit 160 may generate a passcode, a username and password combination, a quick access (QR) code, a token, or other suitable authentication credentials specific to the non-monetary media deposited. In other embodiments, the authentication circuit may initiate a near field communication (NFC) between the ATM and a user device 106 of the user. The authentication circuit 160 may require the ATM and the user device 106 be within a proximity of each other (e.g., 10 cm, 20 cm, etc.) in order to process an NFC tap of a token associated with the ATM to the user device 106. In this way, the user who deposited the non-monetary media may subsequently present the authentication credentials (e.g., passcode, QR code, subsequent NFC communication, etc.) to the ATM to retrieve the non-monetary physical media.

The user device 106 may include a mobile device associated with an ATM user. The user may be individuals (e.g., a customer, a non-customer), business entity representatives, government entity representatives, and so on. The user device 106 is structured to exchange data over the network 110, execute software applications, access websites, generate graphical user interfaces, and perform other operations described herein. The user device 106 may include one or more of a smartphone or other cellular device, a wearable computing device (e.g., a watch or bracelet, etc.), a tablet, a portable gaming device, a laptop, and other portable computing devices. The user device 106 includes a network interface circuit 162, an input/output circuit 164, a display device 166, and a processing circuit 168. The network interface circuit 162 is configured or structured to establish connections via the network 110 between the user device 106, the ATM computing system 102, and the financial institution computing system 104 similar to the network interface circuits discussed above. The processing circuit 168 includes a processor 170 and a memory 172. The processing circuit 168 may be communicably coupled to the ATM computing system 102 and/or the financial institution computing system 104.

The network interface circuit 162 is structured to receive communications from and provide communications to the user of the user device 106 associated with a transaction at the ATM. The network interface circuit 162 includes hardware and associated logic (e.g., instructions, computer code, etc.) to enable the user device 106 to exchange information with a user and other devices (e.g., the financial institution computing system 104, the ATM computing system 102) that may interact with the user device 106. The network interface circuit 162 may provide information to access a banking channel hosted on the ATM computing system 102 created by and for the non-customer. The information may also authentication credentials including a passcode, key, command, or the like to retrieve non-monetary physical media deposited by the customer or non-customer into a repository of the ATM.

The input/output circuit 164 may include any combination of hardware components, for example, a mechanical keyboard, a touchscreen, a microphone, a camera, a fingerprint scanner, a device that is able to be coupled to the user device 106 via a connection (e.g., USB, serial cable, Ethernet cable, etc.), and so on. The output aspect of the input/output circuit 164 allows the user to receive information from the user device 106, and may include, for example, a digital display, a speaker, illuminating icons, light emitting diodes (“LEDs”), and so on. Thus, the input/output circuit 164 may include systems, components, devices, and apparatuses that serve both input and output functions; only input functions; and/or only output functions. The input/output circuit 164 may include communication circuitry for facilitating the exchange of data, values, messages, and the like between an input and/or output device and the components of the user device 106.

In some embodiments, the display device 166 may be a screen, such as a touchscreen or another display device. The user device 106 may communicate information to the user via a user interface displayed or rendered on the display device 166 and/or to receive communications from the user (e.g., through a keyboard provided on the display device 166). In some embodiments, the display device 166 may be a component of the input/output circuit 164, as described above.

Turning to FIG. 2, a block diagram illustrating an ATM 140 (e.g., a transaction device) is shown, according to an embodiment. The ATM 140 may include an ATM system, a standalone terminal/kiosk, or another suitable computing system capable of performing the transactions disclosed herein. The ATM 140 includes the ATM computing system 102 shown in FIG. 1. The ATM 140 may also comprise a user interface 180, a transport apparatus 190, and a vault 192.

The user interface 180 may include at least one media aperture 181 and input/output devices 182. The media aperture 181 is configured to receive non-monetary media into the storage repository 196 of the ATM 140. Additionally, the media aperture 181 may retrieve non-monetary media from the storage repository 196 and provide the non-monetary media to a user of the ATM 140. In still further embodiments, the media aperture 181 may be configured to allow access to and from the storage repository 196. For example, the media aperture 181 may include a slot, a door, a drop-box, a conveyor, an arm, a movable appendage, one or more rollers, a window configured to open and close, or another suitable device for receiving and retrieving/dispensing non-monetary media. In other arrangements, each media aperture 181 may be structured to receive and/or dispense a specific type of non-monetary media (e.g., phones, passports, documents, letters, jewelry, etc.). For example, phones may be inserted via a media aperture 181 comprising a slot, while larger non-monetary items like handbags may be inserted via a media aperture 181 comprising a door and lock. In some arrangements, the media aperture 181 is a media pocket and a user (e.g., a customer or a non-customer) can retrieve and/or place non-monetary media from/in the media pocket. In some arrangements, the media aperture 181 is operable between an open position and a closed position and/or a locked state and an unlocked state. For example, the media aperture 181 may be operable to the open position when receiving or dispensing non-monetary media and operable to the closed position when the ATM 140 is inactive/storing the non-monetary media.

The user interface 180 may also include one or more input/output devices 182. The input/output devices 182 are configured to allow the user to interact with the ATM 140 by submitting user data, making selections on the ATM 140, depositing monetary items and/or non-monetary media, withdrawing monetary items and/or non-monetary media, receiving information from the ATM 140, authenticating and providing security information to the ATM 140, and otherwise facilitating a user to operate/navigate the functionalities of the ATM 140. For example, the input/output devices 182 may include a card reader structured to receive an input from a transaction card (e.g., an ATM card, a credit card, a debit card, a gift card) and/or a security card (e.g., an identification card). The input devices may be configured to read a RFID signal, a magnetic strip, a security chip, and/or any other input signal. In some arrangements, the I/O devices 182 may include a keypad, keyboard, touchscreen, speaker, microphone, or other typing device structured to receive a user input including an alphanumeric input, or other touch input. In some arrangements, the I/O devices 182 includes a biometric sensor structured to receive a biometric from a user such as a fingerprint scan, an eye scan, a face scan, and the like. The I/O devices 182 may further include a screen, a display, a device (e.g., a user device 106) communicatively coupled to the ATM 140, or other suitable devices.

The vault 192 may include a secure housing defining an area within the ATM 140 that may include a monetary receptacle 194 and a storage repository 196. The vault 192 may divided into one or more compartments that define the monetary receptacle 194 and/or the storage repository 196. In some embodiments, the monetary receptacle 194 and the storage repository 196 may be located in the same compartment of the vault 192 or otherwise share space within the ATM 140. The monetary receptacle may be configured to receive and sort physical currency by denomination, receive, read, cash, and/or otherwise process checks or other monetary items. The storage repository 196 may be configured to receive any type of non-monetary media. The storage repository may be accessible via one or more media apertures 181. For example, the storage repository 196 may include a door and be configured as a safety deposit box integrated into the ATM 140. In other embodiments, the storage repository 196 may include one or more internal compartments configured to receive and dispense non-monetary media. For example, the storage repository 196 may include one or more chambers, racks, cartridges, shelfs, etc. for storing keys, phones, jewelry, documents, letters, and the like.

The transport apparatus 190 is configured to securely transport currency items, non-monetary media, and/or both to the monetary receptacle 194 and the storage repository 196, respectively. For example, the transport apparatus 190 may include a lift, arm, tube, conveyor, or other device operable to receive currency and/or non-monetary media, deliver the currency and/or non-monetary media to the vault 192, retrieve the currency and/or non-monetary media from the vault 192, and provide the currency or non-monetary media to the user of the ATM 140.

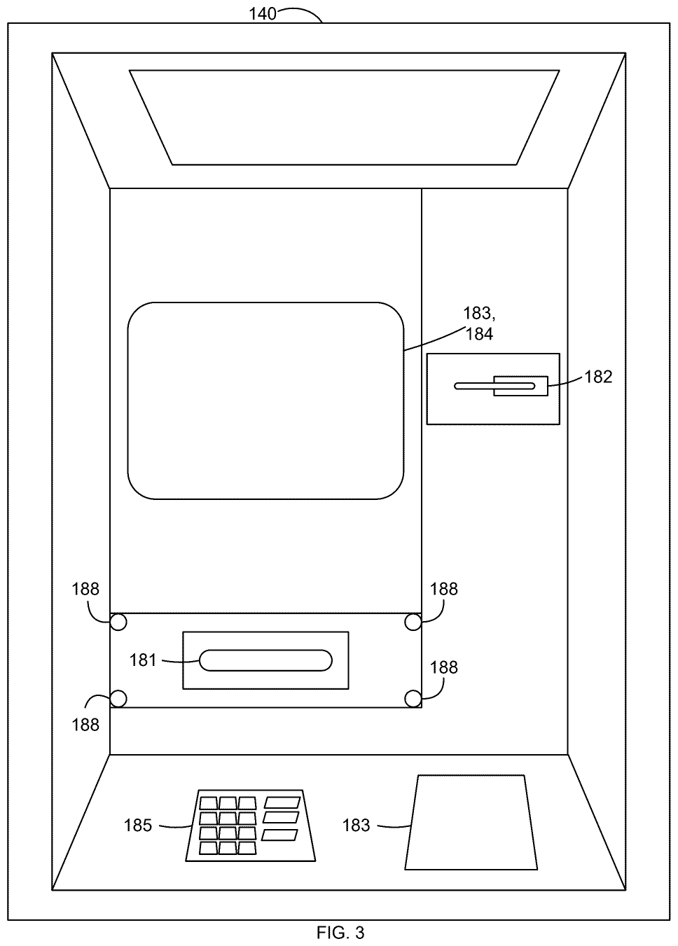

Turning to FIG. 3, a front elevated view of the ATM 140 is illustrated, according to an example arrangement. As shown in FIG. 3, the ATM 140 includes at least one media aperture 181, an ATM display 184, the input/output device 182, and a touchpad 183. As shown in FIG. 3, the input/output devices 182 may include a card reader, an ATM keyboard 185, a touch screen, biometric input, a QR reader, and the like. Various other input/output devices 182 may also be included such as a currency input/dispenser, a receipt dispenser, etc.

The ATM 140 also includes the at least one media aperture 181. In some arrangements, the ATM 140 also includes one or more mounting devices 188 configured to couple the media aperture 181 or a component associated with the media aperture 181 (e.g., a housing, a chute/panel leading to the vault 192, etc.) to the ATM 140. In some arrangements, the ATM 140 may include more than one media aperture 181. For example, the media apertures 181 may include a slot, input tray, drawer, or other suitable device on an elevated portion of the ATM 140 and may include one or more doors 199 configured to selectively allow access to the storage repository 196 on a lower portion of the ATM 140.

The ATM display 184 is a display output structured to display a user interface. The user interface (UI) may include a transactional UI structured to facilitate a transaction. The transactional UI may be displayed during transaction operations performed by the ATM 140. The UI may also include a service mode UI structured to facilitate a service operation (e.g., may allow a technician or provider to access the monetary receptable and/or storage compartment to conduct maintenance, etc.). The transactional UI may include any number of interactive elements or icons for facilitating the services for storing non-monetary media.

The I/O devices 182 may include at least one I/O device for facilitating an operation (e.g., a transactional operation and/or a service mode operation) at the ATM 140. The one or more mounting devices 188 may include any combination of fasteners, pins, magnets, snap fit devices, holes, and/or receptacles for coupling the media aperture 181 to the ATM 140.

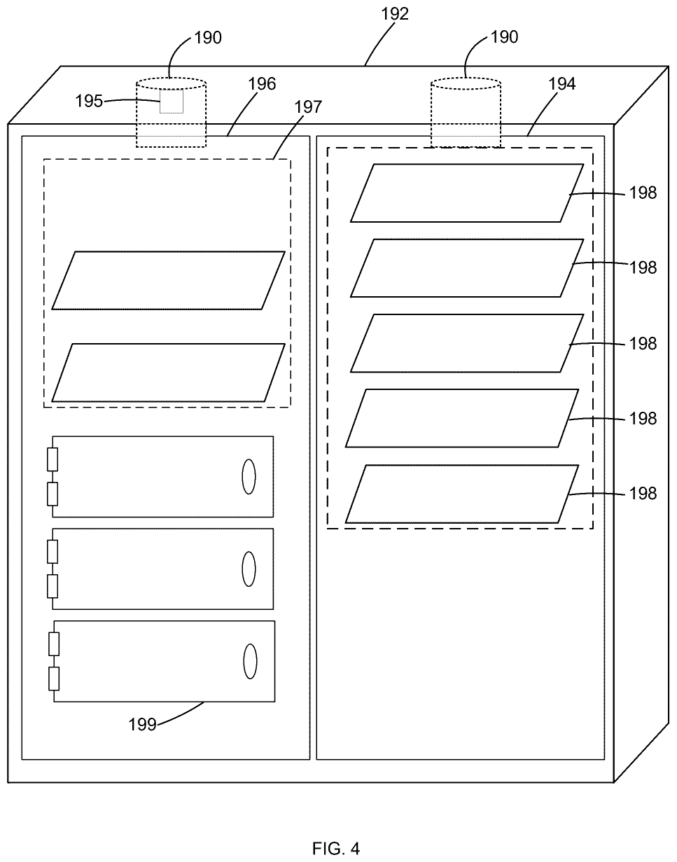

FIG. 4 is an internal view of a lower portion of the ATM 140 of FIG. 3, according to an example arrangement. As shown in FIG. 4, the ATM 140 includes a vault 192 defined in the lower portion. The vault 192 includes, in this example, two compartments, one configured as a monetary receptacle 194, and the other configured as a storage repository 196 for non-monetary media. The monetary receptacle 194 may include one or more cassette slots 198 for receiving physical currency, banknotes, and the like. In some arrangements, the one or more transport apparatus 190 is coupled to the monetary receptacle 194 and/or the storage repository 196.

As shown in FIG. 4, the storage repository 196 may include multiple compartments configured to store respective non-monetary media. For example, the example storage repository 196 of FIG. 4 includes three doors 199 (e.g., media apertures 181) that may each lead to a separate compartment configured to securely store non-monetary media for a customer or non-customer. In this way, the compartments including doors 199 may be used to retrievably store non-monetary media. Also shown in FIG. 4, the storage repository 196 may also define an area 197 accessible only via the transport apparatus 190. In this way, the transport apparatus 190 may prevent users from reaching inside or otherwise gaining direct access to the area 197 of the storage repository 196. For example, the area 197 may include a compartment configured to irretrievably receive and store non-monetary media until accessed by a technical or provider representative. For example, a user may insert a cell phone that the user is to exchange for currency. The media aperture 181 may accept the cell phone, and the ATM may verify the identity of the cell phone. Once verified, the transport apparatus 190 may deposit the cell phone in a holding chamber, such as area 197, and dispense currency for the user. A technician or provider representative may then later collect the accumulated items in the area 197. In some embodiments, the storage repository 196 may be configured to communicate to the processing circuit 132 and/or the financial institution computing system 104 regarding the amount of space available within the storage repository 196. For example, sensors may detect the presence of one or more objects in the storage repository, a weight of objects in the storage repository, or the like, and correlate the weight or number of objects with a percentage of capacity occupied by non-monetary media. The processing circuit 132 may then send an alert to the provider institution indicating that a collection operation should occur to collect deposited items and provide additional space for non-monetary media.

Further, in some embodiments, the ATM 140 may include one or more sensors 195. The sensors 195 may be configured to collect data indicative of an identity of the at least one non-monetary media. For example, the sensors may include cameras, RFID readers, QR scanners, barcode scanners, imaging and vision systems, or other sensors configured to collect data indicative of the identity of the non-monetary media. The data may include a shape, color, weight, size, product number, electrical reading, produce code, photograph, or other information to confirm the identity of the non-monetary media. In some embodiments, the ATM 140 may flash, light up, trigger a sound, or otherwise contact an attendant to arrive at the ATM 140 and manually confirm the identity of the non-monetary media. The ATM 140 may then receive the at least one non-monetary media in the storage repository, and responsive to identifying the at least one non-monetary media, provide the user with a monetary value associated with the identified non-monetary media (e.g., via the output device such a currency dispenser). The ATM 140 may be configured to receive one or more predefined non-monetary media and correlate the identified non-monetary media with an associated currency value by looking up the non-monetary media in a look-up table, performing a search of a price catalog or market rate for the non-monetary media via a communication channel, or via another heuristic such as an AI cost approximation or the like.

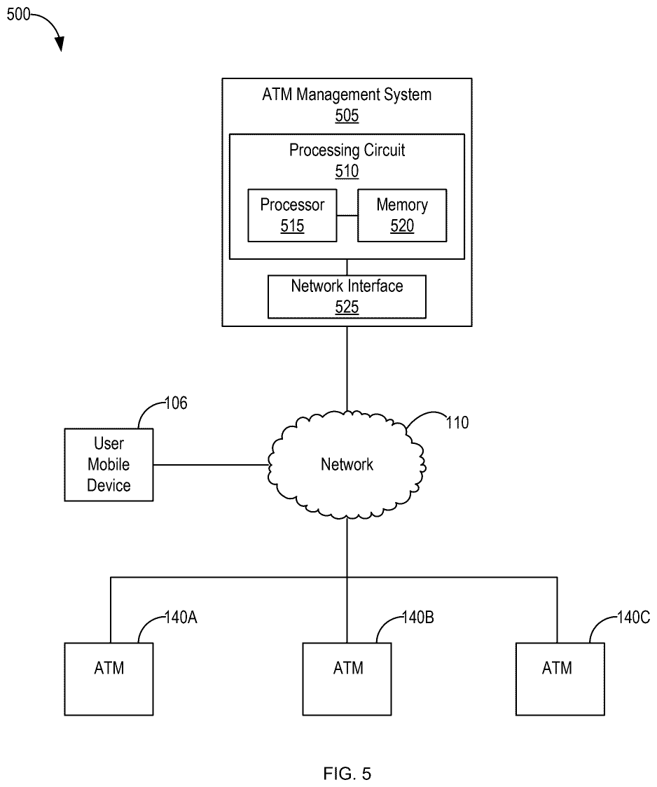

FIG. 5 is a block diagram of a system 500 for proactive ATM management, according to some embodiments. In some embodiments, the system 500 can include at least one ATM management system 505. The ATM management system 505 can include at least one of the various systems, devices, and/or components described herein. For example, the ATM management system 505 can include the financial institution computing system 104. As another example, the ATM management system 505 can include the authentication circuit 160.

In some embodiments, the system 500 can include at least one of the various systems, devices, and/or components described herein. For example, (as shown in FIG. 5) the system 500 includes the network 110, the user device 106, and the ATM 140 (shown as ATM 140A, ATM 140B, and ATM 140C). In some embodiments, the system 500 may be modified, adjusted, changed, and/or otherwise altered to add, remove, replace, relocate, substitute, and/or otherwise supplement at least one system, device, and/or component of the system 500. For example, the system 500 may be modified to add one or more additional user devices 106.

In some embodiments, the ATM management system 505 may include at least one processing circuit 510 and at least one network interface 525. The processing circuit 510 may be communicably coupled with the network interface 525. For example, the processing circuit 510 may transmit one or more signals via the network interface 525 over the network 110 to one or more of the other (e.g., remotely located) devices/components/elements shown in FIG. 5. As another example, the processing circuit 510 may receive one or more signals via the network interface 525 over the network 110 from one or more of the other (e.g., remotely located) devices/components/elements shown in FIG. 5. In some embodiments, the processing circuit 510 may include at least one processor 515 and memory 520. The memory 520 may include one or more memory devices (e.g., RAM, NVRAM, ROM, Flash Memory, hard disk storage) that store data and/or computer code for facilitating the various processes described herein. For example, the memory 520 may store firmware, software, and/or executable code that causes, when executed by the processors 515, the processors 515 to perform at least one of the processes described herein. The memory 520 may be or include tangible, non-transient volatile memory and/or non-volatile memory.

In some embodiments, the processors 515 may be implemented as one or more processors, application specific integrated circuits (ASIC), one or more field programmable gate arrays (FPGAs), a digital signal processor (DSP), a group of processing components, or other suitable electronic processing components. In some embodiments, the processing circuit 510 may perform or assist in performing any of the operations, steps, or methods discussed herein. In some embodiments, the network interface 525 may be used to establish connections, via the network 110, between the ATM management system 505 and at least one of the user device 106 and/or the ATMs 140. For example, the ATM management system 505 may transmit one or more signals by the network interface 525, via the network 110, to the user device 106. In some embodiments, the network interface 525 may perform operations similar to that of the network interface circuit 150. As another example, the network interface 525 may include hardware and/or circuitry similar to that of the network interface circuit 150.

In some embodiments, the ATM management system 505 may continuously and/or semi-continuously communicate with one or more systems of the system 500. For example, the ATM management system 505 may transmit and/or receive sequential signals, via the network 110, from the user device 106 to communicate with the user device 106. In some embodiments, the ATM management system 505 may prompt and/or query various systems for information.

In some embodiments, the processing circuit 510 may monitor one or more interactions. For example, the processing circuit 510 may monitor interactions with the ATMs 140. In some embodiments, the processing circuit 510 may monitor interactions based on information transmitted by and/or provided by the ATMs 140. For example, the ATMs 140 may transmit one or more signals to the ATM management system 505 to indicate various interactions with given ATMs 140. As another example, the ATMs 140 may store, in memory 136, one or more databases and/or data structures that include information pertaining to various interactions with the ATMs 140. To continue this example, the processing circuit 510 may monitor interactions by retrieving, from the databases, the information pertaining to various interactions.

In some embodiments, the processing circuit 510 may continuously monitor and/or semi-continuously monitor the interactions with the ATMs 140. For example, the processing circuit 510 may query, at one or more predetermined points in time, the ATMs 140 for information to indicate interactions with the ATMs 140. As another example, the processing circuit 510 may track or log interactions, with given ATMs 140, in real-time. As even another example, the processing circuit 510 may track and/or count withdrawals, deposits, account creations, account modifications, resource amounts, and/or other possible interactions with the ATMs 140.

In some embodiments, the processing circuit 510 may detect one or changes to statuses of the ATMs 140. For example, the processing circuit 510 may detect a change in a given ATM from a first status to a second status. To continue this example, the first status may be that a card reader for the given ATM is operational (e.g., able to read cards) and the second status may be that the card reader experienced a fault. In some embodiments, the first status and the second status may refer to and/or indicate a change in the given ATM (e.g., a change in resources available, a change in operation of the ATM, a change in traffic patterns with the ATM, a change in wait time for the ATM, and/or a change in operation of the ATM). As another example, the processing circuit 510 may detect that a given ATM has experienced a fault (e.g., change from an operational status to a malfunctioned state). In some embodiments, the processing circuit 510 may detect the one or more changes based on information obtained while monitoring the ATMs 140. For example, the processing circuit 510 may monitor resource amounts for a given ATM 140. To continue this example, the processing circuit 510 may detect, based on a change in the resource amounts for the given ATM 140, that the given ATM 140 has changed from a first status to a second status.

In some embodiments, the changes in the status of the ATMs 140 may include at least one of an amount of resources falling below a first threshold, a detection of a fault in an authentication device of a given ATM, an amount of time to complete one or more interactions with the given ATM exceeding a second threshold, and/or one or more interactions with the given ATM exceeding a third threshold. For example, the processing circuit 510 may detect a change from a first status to a second status for a given ATM 140 based on an average amount of time to complete an interaction with the given ATM 140 exceeding a predetermined threshold. As another example, the processing circuit 510 may detect a change from a first status to a second status for a given ATM 140 based on a number of interactions, with the given ATM 140, within a given amount of time.

As another example, the processing circuit 510 may receive a signal from an ATM 140 regarding an authentication device. To continue this example, the signal may indicate a failed attempt at authentication due to an error in the authentication device (e.g., the card reader is unable to read the card or magnetic strip, sticky keys on the keypad, etc.). As another example, the processing circuit 510 may receive a signal from the ATM 140 that indicates a number of attempts to complete a transaction (e.g., an interaction) within a given amount of time.

In some embodiments, the processing circuit 510 may identify one or more geographical regions. For example, the processing circuit 510 may identify a geographical region that includes a given ATM 140. In some embodiments, the processing circuit 510 may identify the geographical regions responsive to detecting changes in statuses for the ATMs 140. For example, the processing circuit 510 may identify a geographical region that includes a given ATM 140 responsive to detecting a change from a first status to a second status for the given ATM 140. In some embodiments, the processing circuit 510 may identify the geographical regions based on information provided by the ATMs 140. For example, the ATMs 140 may include locational information in one or more signals transmitted to the ATM management system 505. To continue this example, the locational information may include an address of a building that includes a given ATM 140.

In some embodiments, the location information may also include GPS coordinates for the given ATM 140. The location information may also indicate a placement and/or location of the given ATM 140 withing a geographical region. As another example, the processing circuit 510 may store, in memory 520, identifiers that pertain to geographical locations of the ATMs 140. To continue this example, the processing circuit 510 may identify the geographical regions based on the geographical locations of the ATMs 140 (by cross referencing an identifier from the stored identifiers to identify the geographic location of the ATM and identify a geographical region which includes or encompasses the geographical location.).

In some embodiments, the processing circuit 510 may retrieve one or more sets of information. For example, the processing circuit 510 may retrieve information that is stored in the memory 520. As another example, the processing circuit 510 may transmit one or more Application Programming Interface (API) calls to retrieve information stored in a remote database. In some embodiments, the processing circuit 510 may retrieve information corresponding to one or more interactions with a given ATM 140. For example, the processing circuit 510 may retrieve information corresponding to interactions with an ATM 140 that has a detected status change (e.g., a change from a first status to a second status). As another example, the processing circuit 510 may retrieve information that identifies interactions with the ATM 140.

In some embodiments, the processing circuit 510 may retrieve information that was collected while monitoring the ATMs 140. For example, the processing circuit 510 may retrieve information that was collected and/or detected while monitoring interactions with the ATMs 140. To continue this example, the information may include indications of a number of withdrawals performed at a given ATM, a number of deposits performed at the given ATM, a remaining amount of resources available at the given ATM, a list of accounts associated with the interactions, an average amount of time to complete one or more interactions, etc.) In some embodiments, the processing circuit 510 may retrieve information based on one or more tags. For example, the processing circuit 510 may apply one or more tags, to given portions and/or given bits of information, to identify what the information represents. To continue this example, the processing circuit 510 may apply a given tag, to a given portion of information, to indicate that the given portion of information corresponds to interactions. In some embodiments, the information corresponding to the interactions may include interaction counts (e.g., number of interactions, interaction types, etc.). For example, the information corresponding to a given ATM 140 may include an indication of a number of interactions with the given ATM 140. As another example, the information may also identify and/or indicate user information, such as account information, profile information, device information, and/or user preferences.

In some embodiments, the processing circuit 510 may identify one or more profiles. For example, the processing circuit 510 may identify one or more profiles based on interactions with the ATMs 140. To continue this example, the processing circuit 510 may tag the interactions with identifiers that indicate a profile associated with the interactions. In this example, the processing circuit 510 may then identify the profiles based on the tag included in the interactions. As another example, the processing circuit 510 may identify profiles associated with one or more interactions with a given ATM 140. To continue this example, the processing circuit may identify profiles that include and/or associated with a number of interactions that exceed a predetermined threshold (e.g., identify profiles of one or more users that frequently visit the ATMs). As another example, the processing circuit 510 may identify one or more profiles that include an address with a given range of the given ATM 140. In some embodiments, the processing circuit 510 may identify the one or more profiles based on the information that corresponded to interactions with the given ATM 140. For example, the information may include a given portion that pertains to a given interaction. To continue this example, the given portion may include information to identify a profile associated with the interaction. As another example, the information may include a list and/or tally of profiles that include at least one interaction with the given ATM 140.

In some embodiments, the processing circuit 510 may determine one or more user devices 106. For example, the processing circuit 510 may determine given user devices 106 associated with and/or linked to one or more profiles identified by the processing circuit 510. In some embodiments, the processing circuit 510 may determine user devices 106 that are enrolled in one or more subscriptions. For example, the processing circuit 510 may determine user devices 106 that are enrolled in a subscription to receive status change updates for a given ATM 140. As another example, the processing circuit 510 may determine user devices 106 that are enrolled in a subscription to receive status change updates based on a location information of the user devices 106.

In some embodiments, the processing circuit 510 may cause one or more user devices 106 to display a user interface. For example, the processing circuit 510 may transmit one or more signals that cause a given user device 106 to display a user interface. As another example, the processing circuit 510 may also transmit one or more signals to cause a given user device 106 to update one or more user interfaces. In some embodiments, the processing circuit 510 may transmit one or more signals responsive to a determination that a given user device 106 is enrolled in one or more subscriptions. For example, the processing circuit 510 may transmit one or more signals to a given user device 106 based on the given user device having a subscription to receive status change updates for a given ATM 140.

In some embodiments, the processing circuit 510 may identify one or more given ATMs 140. For example, the processing circuit 510 may identify given ATMs 140 that are located proximate to a first ATM 140. As another example, the processing circuit 510 may identify given ATMs that are within a predetermined proximity to a first ATM 140. In some embodiments, the processing circuit 510 may identify the given ATMs 140 based on a geographical region that includes the first ATM 140. For example, the processing circuit 510 may identify given ATMs 140 that are within a two-block radius of a first ATM 140. As another example, the processing circuit 510 may identify one or more given ATMs 140 that are located within a geographical region that also includes the first ATM 140. As even another example, the processing circuit 510 may identify one or more given ATMs 140 that were previously visited by one or more users (e.g., the users previously performed at least one interactions with the one or more given ATMs 140). As even another example, the processing circuit 510 may identify the one or more given ATMs based one a home address and/or work address listed in the profiles. In some embodiments, the processing circuit 510 may identify the one or more given ATMs 140 based on a change in a status for a given ATM 140. For example, the processing circuit 510 may identify given ATMs 140 based on a change from a first status to a second status of a first ATM 140.

In some embodiments, the processing circuit 510 may determine one or more statuses. For example, the processing circuit 510 may determine statuses for one or more ATMs 140 that were identified based on a geographical region that includes a first ATM 140. In some embodiments, the processing circuit 510 may determine the statuses for the ATM 140 by retrieving information that corresponds to the ATMs 140. For example, the processing circuit 510 may retrieve information that identifies interactions with the ATMs 140. In some embodiments, the processing circuit 510 may determine that statuses of the ATMs 140 based on the interactions. For example, the processing circuit 510 may determine available resources, for a given ATM 140, based on a difference between a starting amount of resources and a total amount of resources withdrawn from the given ATM 140.

In some embodiments, the processing circuit 510 may cause the user devices 106 to update the user interface. For example, the processing circuit 510 may transmit subsequent signals that cause, when received by the user devices 106, the user devices 106 to update the user interface. As another example, the processing circuit 510 may transmit signals that cause various types of information to be overlayed on top of the user interface displayed by the user devices 106. In some embodiments, the processing circuit 510 may update the user interface to identify the statuses of one or more ATMs 140. For example, the processing circuit 510 may cause the user interface to include one or more overlays that identifies statuses for one or more ATMs 140 based on a change in a status for a first ATM 140.

In some embodiments, the processing circuit 510 may determine one or more features. For example, the processing circuit 510 may determine features available from one or more ATMs 140. In some embodiments, the processing circuit 510 may determine one or more features available for a given ATM 140 based on a change from a first status to a second status for the given ATM 140. For example, the processing circuit 510 determine that the given ATM 140 can receive deposits (e.g., a feature). As another example, the processing circuit 510 may determine that the given ATM 140 can provide withdrawals that are less than a given amount (e.g., a feature). As even another example, the processing circuit 510 may determine that the vault 192 for the given ATM 140 can receive non-monetary deposits, such as keys, phones, jewelry, and the like.

In some embodiments, the processing circuit 510 may detect one or more presences. For example, the processing circuit 510 may detect one or more users that are proximate to the ATMs 140. As another example, the processing circuit 510 may monitor location information regarding the user devices 106. To continue this example, the processing circuit 510 may detect that the user devices 106, based on location information (e.g., GPS coordinates or other location data) provided by the user devices 106 to the processing circuit 510, is proximate to one or more ATMs 140. As even another example, the processing circuit 510 may receive data collected by the sensors 195 (e.g., NFC data, Bluetooth data, image data, video feeds, etc.). To continue this example, the processing circuit 510 may use computer vision to detect one or more users included in the data.

In some embodiments, the processing circuit 510 may cause one or more ATMs 140 to display user interfaces. For example, the ATM display 184 may be off and/or idle at a first point in time. To continue this example, the processing circuit 510 may cause the ATM display 184 to display one or more user interfaces. In some embodiments, the processing circuit 510 may cause the ATMs 140 to display a user interface responsive to detection of a presence. For example, the processing circuit 510 may receive a signal from a proximity sensors of the ATMs 140 which indicates a person within range of the proximity sensor. To continue this example, the processing circuit 510 may generate a user interface responsive to receiving the signal from the proximity sensor. In some embodiments, the processing circuit 510 may cause the ATM 140 to display a user interface to identify information corresponding to a given ATM 140. For example, the processing circuit 510 may cause a given ATM 140 to display a user interface to identify a status of the given ATM 140. As another example, the processing circuit 510 may cause the given ATM 140 to display a user interface to identify one or more features available from the given ATM 140.

In some embodiments, the processing circuit 510 may prompt the user devices 106. For example, the processing circuit 510 may cause the user devices 106 to display a user interface that includes one or more prompts. As another example, the processing circuit 510 may transmit one or more signals to prompt the user device 106 to provide information. In some embodiments, the processing circuit 510 may prompt the user devices 106 to identify one or more interactions. For example, the processing circuit 510 may prompt the user device 106 to identify future and/or potential interactions. Stated otherwise, the processing circuit 510 may prompt the user device 106 to provide an indication of what interaction a user was planning to perform with a given ATM 140.

In some embodiments, the processing circuit 510 may receive one or more indications. For example, the processing circuit 510 may receive indications responsive to prompting the user devices 106. As another example, the processing circuit 510 may prompt the user device 106 to identify one or more interactions based on a change in a status to a given ATM 140. To continue this example, the user device 106 may provide an indication to identify that a user was planning to withdraw a given amount of resources from the given ATM 140. In this example, the processing circuit 510 may identify one or more subsequent ATMs 140 for which the user may perform the interaction (e.g., withdraw).

In some embodiments, the processing circuit 510 may receive one or more first indications from a first user device 106. For example, the processing circuit 510 may receive indications, from the first user device 106, that identify subsequent interactions. To continue this example, the indications may include a list of the subsequent interactions. As another example, a user of the user device 106 may select one or more boxes and/or icons included in a user interface to identify the subsequent interactions.

In some embodiments, the processing circuit 510 may identify one or more ATMs 140 based on interactions identified by the user devices 106. For example, the processing circuit 510 may receive an indication of a first interaction. To continue this example, the processing circuit 510 may identify one or more ATMs 140 that may be configured to execute and/or complete the first interaction. In some embodiments, the processing circuit 510 may identify the ATMs 140 based on the interaction and at least one of a location of the ATMs 140, a location of the user devices 106, and/or account settings associated with one or more accounts. For example, the processing circuit 510 may identify a first ATM 140 and a second ATM 140 based on a given interaction. To continue this example, the processing circuit 510 may then select the first ATM 140 based on a location of the first ATM 140 relative to a location of a given user device 106.

In some embodiments, the processing circuit 510 may cause one or more user interfaces to be displayed. For example, the processing circuit 510 may cause a given user device 106 to display a user interface responsive to the processing circuit 510 identifying one or more ATMs 140. As another example, the processing circuit 510 may cause the given user device 106 to display a user interface responsive to receiving one or more indications from the ATMs 140. In some embodiments, the processing circuit 510 may cause the user devices 106 to display a user interface to identify and/or include given information. For example, the processing circuit 510 may cause the user devices 106 to display a user interface to identify locations of one or more ATMs 140 that were identified by the processing circuit 510. As another example, the processing circuit 510 may cause the user devices 106 to display a user interface to include a list of features available by the ATMs 140.

In some embodiments, the processing circuit 510 may adjust demands placed on one or more ATMs 140. For example, the processing circuit 510 may adjust demands for a given ATM 140 based on a number of interactions with the given ATM 140 exceeding a predetermined threshold. As another example, the processing circuit 510 may adjust demands for a given ATM 140 based on a number of interactions of a given interaction type (e.g., withdraw, deposit, etc.). In some embodiments, the processing circuit 510 may adjust demands placed on one more ATMs 140 by causing one or more user interfaces to be displayed. For example, the processing circuit 510 may adjust demands for a given ATM 140 by causing one or more first user devices 106 to display a user interface to identify locations of one or more (e.g., alternative) ATMs 140 to reduce a demand for a given ATM 140. To continue this example, the processing circuit 510 may cause one or more second user devices 106 to display a user interface to identify locations of one or more second ATMs 140.

In some embodiments, the processing circuit 510 may cause one or more user interfaces to be displayed that identify given interaction information. For example, the processing circuit 510 may cause the user devices 106 to display user interfaces that identify a predicted amount of time to interact with a given ATM 140 (e.g., duration of an interaction, a wait time prior to an interaction, etc.). As another example, the processing circuit 510 may cause the ATMs 140 to display user interfaces to identify predicted wait times and/or predicted interaction times.

In some embodiments, the processing circuit 510 may detect a change from a first status to a second status based on a detection of one or more faults. For example, the processing circuit 510 may detect a change from a first status to a second status based on a detected fault in a given authentication device for the ATMs 140 (e.g., card reader, biometrics, scanner, etc.). In some embodiments, the processing circuit 510 may detect the faults based on information transmitted by the ATMs 140. For example, the processing circuit 510 may detect that a given authentication device has experienced a fault based on information that corresponds to the given authentication device.

In some embodiments, the processing circuit 510 may retrieve one or more sets of information based on a detected change from a first status to a second status for a given ATM 140. For example, the processing circuit 510 may retrieve information that identifies authentication devices for a given ATM 140 based on a fault to a given authentication device for the given ATM 140. In some embodiments, the processing circuit 510 may store, in memory 520, a data structure that includes a list of authentication devices for the ATMs 140. For example, the data structure may identify that a first ATM 140 includes the sensors 195 and a card reader (e.g., the I/O devices 182). As another example, the data structure may identify that a second ATM 140 includes NFC authentication and a face recognition device (e.g., the sensors 195).

In some embodiments, the processing circuit 510 may query the ATMs 140 to provide information that corresponds to one or more authentication devices. For example, the processing circuit 510 may query the ATMs 140 to provide information that corresponds to the sensors 195. To continue this example, the information may include diagnostic information. In this example, the processing circuit 510 may determine a status of the sensors 195.

In some embodiments, the processing circuit 510 may detect one or more authentication devices that can be used to authenticate interactions. For example, the processing circuit 510 may detect one or more authentications devices that are operational based on information provided by the ATMs 140. As another example, the processing circuit 510 may detect the authentication devices responsive to receiving a response to one or more queries.

In some embodiments, the processing circuit 510 may cause one or more user interfaces to identify the authentication devices. For example, the processing circuit 510 may cause the user devices 106 to display a user interface that includes a list of authentication devices that are available at a given ATM 140. As another example, the processing circuit 510 may cause the ATMs 140 to display a user interface that identifies one or more authentication devices available at the ATMs 140.

In some embodiments, the processing circuit 510 may receive one or more indications. For example, the processing circuit 510 may receive indications that identify one or more statuses of the ATMs 140. To continue this example, the processing circuit 510 may receive an indication that a card reader for a given ATM 140 is currently experiencing a fault. In some embodiments, the processing circuit 510 may receive an indication of a given status for a given ATM 140 from a user device 106 (e.g., a user device 106 that is proximate to the given ATM 140). For example, the processing circuit 510 may receive an indication from a user device 106 that is attempting to communicate with the given ATM 140. In some embodiments, the processing circuit 510 may receive the interaction responsive to an interaction with a mobile application stored in the user device 106. For example, the user device 106 may provide the indication of the status of the given ATM 140 by selecting an icon displayed in a mobile application.

In some embodiments, the processing circuit 510 may detect a change from a first status to a second status based on information provided by the user devices 106. For example, the processing circuit 510 may receive, from the user device 106, an indication that the sensors 195 for a given ATM 140 are currently experiencing a fault. To continue this example, the processing circuit 510 may detect, responsive to receipt of the indication, a change from a first status (e.g., operable) to a second status (e.g., experiencing a fault) for the given ATM 140. In some embodiments, the processing circuit 510 may query the given ATM 140 based on the indication received from the user device 106. For example, the processing circuit 510 may query the sensors 195 to confirm whether the card reader is operational. As another example, the processing circuit 510 may access and/or view a live feed from a camera to determine if the camera is operational.

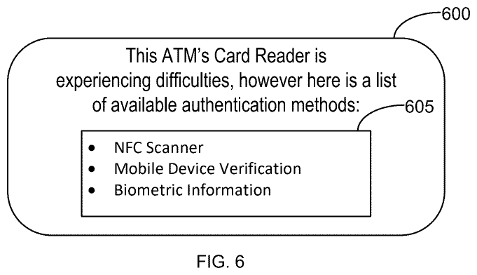

FIG. 6 is a user interface 600, according to some embodiments. In some embodiments, the processing circuit 510 may cause at least one device to display the user interface 600. For example, the processing circuit 510 may transmit one or more signals that, when received by the device, cause the device to display the user interface 600. In some embodiments, the user interface 600 may be displayed by the display device 166. For example, the display device 166 may display the user interface 600 responsive to receiving one or more signals from the processing circuit 510. In some embodiments, the ATM display 184 may display the user interface 600.

In some embodiments, the user interface 600 may be displayed responsive to one or more interactions with the ATM 140. For example, the ATM display 184 may display the user interface 600 responsive to a user initiating an interaction with a given ATM 140. In some embodiments, a user may interface with and/or interact with the user interface 600. For example, a user may select one or more icons and/or elements included in the user interface 600. In some embodiments, the user interface 600 may include at least one of the various user interfaces described herein. For example, the user interface 600 may display information to identify statuses for one or more ATMs 140. In some embodiments, the user interface 600 may receive information that is then provided to the processing circuit 510. For example, the user interface 600 may receive one or more indications and the indications may then be provided to the processing circuit 510.

In some embodiments, the user interface 600 may include a message that identifies that status of one or more authentication devices for a given ATM 140. For example, as shown in FIG. 6, the user interface 600 includes a message that identifies that a card reader for a given ATM 140 is experiencing difficulty. In some embodiments, the user interface 600 may include at least one list 605. For example, as shown in FIG. 6, the list 605 includes a list of authentication devices that are available at the ATM 140.

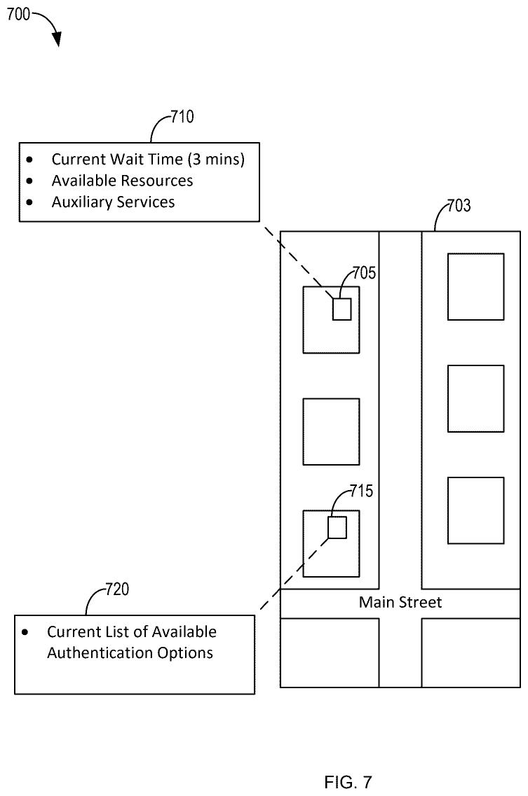

FIG. 7 is a user interface 700, according to some embodiments. In some embodiments, the processing circuit 510 may cause at least one device to display the user interface 700. For example, the processing circuit 510 may transmit one or more signals that, when received by the device, cause the device to display the user interface 700. In some embodiments, the user interface 700 may be displayed by the display device 166. For example, the display device 166 may display the user interface 700 responsive to receiving one or more signals from the processing circuit 510. In some embodiments, the ATM display 184 may display the user interface 700.

In some embodiments, the user interface 700 may displayed in conjunctive with the user interface 600. For example, the user interface 700 and the user interface 600 may be combined and the information included in the user interfaces may be viewed and/or showing by scrolling through and/or otherwise navigating a user interface that includes the user interface 700 and the user interface 600. As another example, the user interface 700 may be display as a pop-up window and/or an overlay on top of the user interface 600. As even another example, the user interface 700 and the user interface 600 may be displayed as separate user interfaces.

In some embodiments, the user interface 700 may include at least one map 703. The map 703 may refer to and/or include a given geographical region. For example, the map 703 may refer to a geographical region that includes at least one ATM 140. In some embodiments, the processing circuit 510 may cause the user interface 700 to be displayed responsive to a detection of a change from a first status to a second status for a given ATM 140. For example, the processing circuit 510 may cause the user interface 700 to be displayed responsive to a detection that a number of interactions with a given ATM 140 exceeds a predetermined threshold. In some embodiments, the user interface 700 may include one or more elements to represent one or more ATMs 140. For example, as shown in FIG. 7, the user interface 700 includes an element 705 to represent a first given ATM 140 and an element 715 to represent a second given ATM 140. In some embodiments, the element 705 and the element 715 may represent ATMs 140 that are proximate to a given ATM 140 that was detected to have changed from a first status to a second status.

In some embodiments, the user interface 700 may include one or more messages to identify information that corresponds to a given ATM 140. For example, as shown in FIG. 7, the user interface 700 includes a message 710 that identifies information that corresponds to element 705 (e.g., the first given ATM 140) and a message 720 that identifies information that corresponds to element 715 (e.g., the second given ATM 140). In some embodiments, the messages (e.g., the message 710 and/or the message 720) may identify information such as, available authentication devices, available resources, predicted wait times, auxiliary services available, and/or various other types of information.

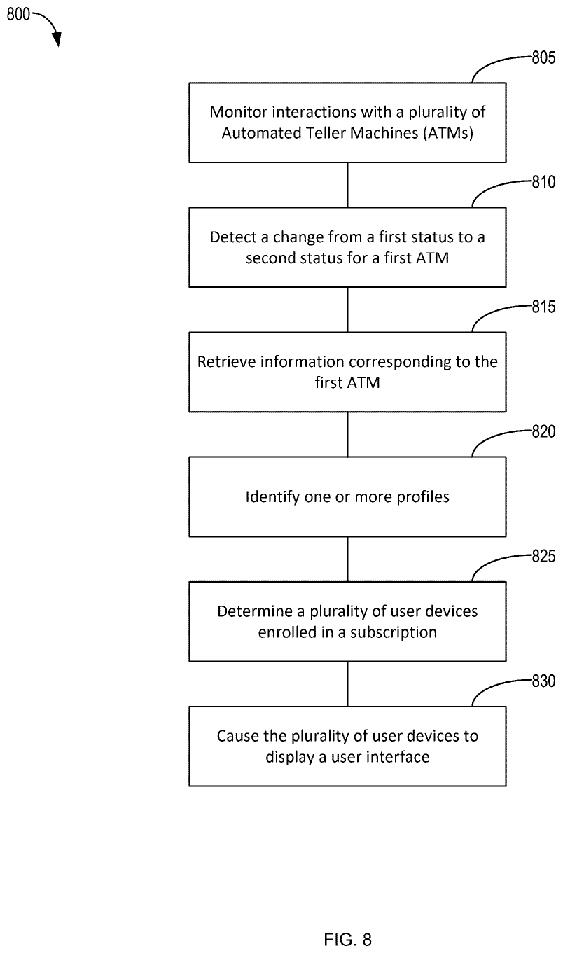

FIG. 8 is a flow diagram of a method 800 for proactive ATM management, according to some embodiments. Various components and/or systems of the system 500 can perform the method 800. Via the method 800, the ATM management system 505 may detect one or more changes in statuses of the ATMs 140. The ATM management system 505 may also provide proactive ATM management by providing indications of the statuses of the ATMs 140, via one or more user interfaces. Additionally, the ATM management system 505 may also provide proactive ATM management by identifying one or more subsequent ATM 140 for which users may perform interactions with.

In step 805, interactions with one or more Automated Teller Machines (ATMs) may be monitored, in some embodiments. For example, the processing circuit 510 monitor interactions with the ATMs 140. To continue this example, the processing circuit 510 may monitor the interactions by collecting and/or obtaining information that corresponds to the ATMs 140. In some embodiments, the information that corresponds to the ATMs 140 may include at least one of a number of interactions a give ATM 140, interaction types, resource amounts, authentication measures, interaction duration, and/or other types of information. In some embodiments, the processing circuit 510 may monitor the interactions by querying the ATMs 140 for the information that corresponds to the interactions. In other embodiments, the processing circuit 510 may monitoring the interactions by retrieving, from databases stored locally by the ATMs 140, the information that corresponds to the interactions.

In step 810, a change from a first status to a second status for a first ATM may be detected, in some embodiments. For example, the processing circuit 510 can detect a change from a first status to a second status for a given ATM 140. To continue this example, the processing circuit 510 may detect the change responsive to monitoring interactions with the given ATM 140 in step 805. In some embodiments, the processing circuit 510 may detect the change from the first status to a second status based on the monitored interaction(s) relative/as compared to one or more thresholds. For example, the processing circuit 510 may detect a change from a first status to a second status based on a number of interactions with a given ATM 140 exceeding a predetermined threshold. As another example, the processing circuit 510 may detect a change from a first status to a second status based on an amount of time, since previous communication with a given ATM 140, exceeding a predetermined threshold. In some embodiments, the change from a first status to a second status for a given ATM may include at least one of an amount of resources falling below a predetermined threshold, a number of interactions exceeding a predetermined threshold, an amount of time for the interactions exceeding a predetermined threshold, and/or a fault in a given authentication device.

In step 815, information corresponding to the first ATM may be retrieved, in some embodiments. For example, the processing circuit 510 may retrieve information that corresponds to the ATM that was detected, in step 810, to have changed from a first status to a second status. In some embodiments, the processing circuit 510 may generate and/or update one or more data structures to include and/or reflect information that is collected while monitoring the ATMs in step 805. For example, the processing circuit 510 may update an interaction count for a given ATM responsive to detecting interactions with the given ATM. As another example, the processing circuit 510 may update resource amounts available at a given ATM responsive to detecting a withdraw of resources from the given ATM.

In step 820, one or more profiles may be identified, in some embodiments. For example, the processing circuit 510 may identify one or more profiles that have interacted with the ATM that was detected, in step 810, to have changed from a first status to a second status. In some embodiments, the processing circuit 510 may identify the one or more profiles based on tags included in interaction information. For example, a given interaction between a profile and an ATM may cause the ATM to generate data. To continue this example, the data may include a tag to identify the profile. In some embodiments, the tags included in the data may be collected by the processing circuit 510 while the processing circuit 510 is monitoring the interactions in step 805.

In step 825, a plurality of user devices enrolled in a subscription may be determined, in some embodiments. In some embodiments, the processing circuit 510 may determine the user devices based on the profiles identified in step 820. For example, each profile identified in step 820 may include device information such a device ID which may be uniquely associated with a corresponding device that is registered and/or otherwise associated with the corresponding profiled identified in step 820. As another example, the processing circuit 510 may determine the user devices based on information that corresponds to the profiles. As another example, a given profile may list and/or identify a user device. To continue this example, the processing circuit 510 may determine the user device responsive to accessing and/or searching the given profile.

In some embodiments, the processing circuit 510 may detect user devices enrolled in one or more subscriptions. For example, the processing circuit 510 may detect user devices enrolled in status updates (e.g., subscriptions) for a given ATM. To continue this example, the user devices may have enrolled in the status updates responsive to a prompt. In this example, the user devices may be prompted to enroll in the subscriptions responsive to completion of one or more interactions with the given ATM. The user devices may also be prompted to enroll in subscriptions based on a relative location of an address associated with the user device and the given ATM. In some embodiments, the user devices may be enrolled in one or more subscriptions based on the user devices having taken part in a number of interactions with a given ATM that exceeds a predetermined threshold. Stated otherwise, a user device may be enrolled in a subscription for a given ATM based on the user device frequently visiting and/or interacting with the ATM.

In step 830, display of a user interface by the plurality of user devices may be caused, in some embodiments. For example, the processing circuit 510 may cause the user device 106 to display a user interface. In some embodiments, the processing circuit 510 may cause the user devices, determined in step 825, to display the user interfaces. For example, the processing circuit 510 may cause one or more user devices enrolled in status updates for a given ATM to display a user interface responsive to a change in a status for the given ATM.

In some embodiments, the processing circuit 510 may cause the user devices to display at least one of the various user interfaces described herein. For example, the processing circuit 510 may cause the user devices to display the user interface 600. In some embodiments, the user interface may identify the status of the ATM. For example, the user interface may include a message to identify a fault for a given authentication device for the ATM.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings. Further, the features present in one drawing may be combined, included, or otherwise interoperate with the features disclosed in another drawing.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud based server). To that end, a “circuit” as described herein may include components that are distributed across one or more locations.

An exemplary system for implementing the overall system or portions of the embodiments might include a general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick, or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

What is claimed is:

1. A computing system, comprising:
at least one processing circuit having at least one processor coupled to at least one memory device, the at least one memory device storing instructions thereon that, when executed by the at least one processing circuit, cause the at least one processing circuit to:
monitor, based on communications with a plurality of Automated Teller Machines (ATMs), a first plurality of interactions with the plurality of ATMs;
detect, subsequent to monitoring the first plurality of interactions with the plurality of ATMs, a change from a first status of a first ATM of the plurality of ATMs to a second status of the first ATM;
retrieve, from a database, responsive to detection of the change from the first status to the second status, information corresponding to a second plurality of interactions with the first ATM;
identify, responsive to retrieval of the information, one or more profiles associated with respective interactions of the second plurality of interactions;
determine, based at least one the one or more profiles, a plurality of user devices enrolled in a subscription to receive status updates regarding the first ATM; and
transmit, responsive to determination of the plurality of user devices, a signal to the plurality of user devices to cause the plurality of user devices to display a user interface to identify the second status of the first ATM.

2. The computing system of claim 1, wherein the instructions cause the at least one processing circuit to:
identify, according to a geographical region that includes the first ATM, one or more second ATMs of the plurality of ATMs located within a predetermined proximity of the first ATM;
determine, based at least on one or more interactions of the first plurality of interactions, statuses of the one or more second ATMs; and
transmit, responsive to determination of the statuses of the one or more second ATMs, a second signal to cause the user interface to identify the statuses of the one or more second ATMs.

3. The computing system of claim 1, wherein the instructions cause the at least one processing circuit to:
determine, based on first information provided by the first ATM, one or more features available from the first ATM;
detect, based on second information provided by the first ATM, a presence of a user proximate to the first ATM;
transmit, responsive to detection of the presence, a second signal to the first ATM to cause the first ATM to display the user interface to identify:
the second status of the first ATM; and
the one or more features available from the first ATM.

4. The computing system of claim 1, wherein the second status of the first ATM includes a number of interactions with the first ATM exceeding a threshold, and wherein the instructions cause the at least one processing circuit to:
prompt, via the user interface, the plurality of user devices to identify subsequent interactions;
receive, via the user interface from a first user device of the plurality of user devices, an indication of a first subsequent interaction;
identify, based at least one the first subsequent interaction, one or more second ATMs of the plurality of ATMs to perform the first subsequent interaction; and
transmit a second signal to the first user device to cause the first user device to update the user interface to:
identify locations of the one or more second ATMs; and
include a list of features available from the one or more second ATMs.

5. The computing system of claim 1, wherein the instructions cause the at least one processing circuit to:
identify, based at least one the second status of the first ATM and a geographical region that includes the first ATM, a set of second ATMs of the plurality of ATMs within a predetermined proximity to the first ATM;
determine, based on previous interactions with the set of second ATMs, statuses of the set of second ATMs; and
adjust a demand for the first ATM by:
transmitting one or more second signals to one or more first user devices of the plurality of user devices to cause the user interface to identify locations of a first subset of the set of second ATMs; and
transmitting one or more third signals to one or more second user devices of the plurality of user devices to update the user interface to identify locations of a second subset of the set of second ATMs.

6. The computing system of claim 1, wherein the instructions cause the at least one processing circuit to:
identify, based on a geographical region that includes the first ATM, one or more second ATMs of the plurality of ATMs proximate to the first ATM;
determine, based on previous interactions with the one or more second ATMs, statuses of the one or more second ATMs, the statuses of the one or more second ATMs including predicted amounts of time to interact with the one or more second ATMs; and
transmit a second signal to the plurality of user devices to cause the user interface to identify the predicted amounts of time to interact with the one or more second ATMs.

7. The computing system of claim 1, wherein the second status of the first ATM is a detection of a fault in a first authentication device of the first ATM, and wherein the instructions cause the at least one processing circuit to:
retrieve, from the database, second information that identifies a plurality of authentication devices of the first ATM, the plurality of authentication devices including the first authentication device;
query the first ATM to provide third information corresponding to the plurality of authentication devices;
detect, based at least one the third information, one or more second authentication devices of the plurality of authentication devices available to authenticate one or more subsequent interactions; and
cause, responsive to detection of the one or more second authentication devices, the first ATM to display a second user interface to identify the one or more second authentication devices.

8. The computing system of claim 1, wherein the second status of the first ATM includes at least one of:
an amount of resources falling below a first threshold;
a detection of a fault in an authentication device of the first ATM;
an amount of time to complete a first number of interactions with the first ATM exceeding a second threshold; or
a second number of interactions with the first ATM exceeding a third threshold.

9. The computing system of claim 1, wherein the instructions cause the at least one processing circuit to:
receive, from a user device proximate to the first ATM, an indication of the second status of the first ATM, wherein the indication is received responsive to an interaction with a mobile application stored in memory of the user device; and
detect, responsive to receipt of the indication of the second status of the first ATM, the change from the first status of the first ATM to the second status of the first ATM.

10. A method, comprising:
monitoring, by a computing system based on communications with a plurality of Automated Teller Machines (ATMs), a first plurality of interactions with the plurality of ATMs;
detecting, by the computing system subsequent to monitoring the first plurality of interactions with the plurality of ATMs, a change from a first status of a first ATM of the plurality of ATMs to a second status of the first ATM;
retrieving, by the computing system from a database, responsive to detecting the change from the first status to the second status, information corresponding to a second plurality of interactions with the first ATM;
identifying, by the computing system responsive to retrieval of the information, one or more profiles associated with respective interactions of the second plurality of interactions;
determining, by the computing system based at least one the one or more profiles, a plurality of user devices enrolled in a subscription to receive status updates regarding the first ATM; and
transmitting, by the computing system responsive to determination of the plurality of user devices, a signal to the plurality of user devices to cause the plurality of user devices to display a user interface to identify the second status of the first ATM.

11. The method of claim 10, comprising:
identifying, by the computing system according to a geographical region that includes the first ATM, one or more second ATMs of the plurality of ATMs located within a predetermined proximity of the first ATM;
determining, by the computing system based at least on one or more interactions of the first plurality of interactions, statuses of the one or more second ATMs; and
transmitting, by the computing system responsive to determination of the statuses of the one or more second ATMs, a second signal to cause the user interface to identify the statuses of the one or more second ATMs.

12. The method of claim 10, comprising:
determining, by the computing system based on first information provided by the first ATM, one or more features available from the first ATM;
detecting, by the computing system based on second information provided by the first ATM, a presence of a user proximate to the first ATM;
transmitting, by the computing system responsive to detection of the presence, a second signal to the first ATM to cause the first ATM to display the user interface to identify:
the second status of the first ATM; and
the one or more features available from the first ATM.

13. The method of claim 10, wherein the second status of the first ATM includes a number of interactions with the first ATM exceeding a threshold, and comprising:
prompting, by the computing system via the user interface, the plurality of user devices to identify subsequent interactions;
receiving, by the computing system via the user interface from a first user device of the plurality of user devices, an indication of a first subsequent interaction;
identifying, by the computing system based at least one the first subsequent interaction, one or more second ATMs of the plurality of ATMs to perform the first subsequent interaction; and
transmitting, by the computing system, a second signal to the first user device to cause the first user device to update the user interface to:
identify locations of the one or more second ATMs; and
include a list of features available from the one or more second ATMs.

14. The method of claim 10, comprising:
identifying, by the computing system based at least one the second status of the first ATM and a geographical region that includes the first ATM, a set of second ATMs of the plurality of ATMs within a predetermined proximity of the first ATM;
determining, by the computing system based on previous interactions with the set of second ATMs, statuses of the set of second ATMs; and
adjusting, by the computing system, a demand for the first ATM by:
transmitting one or more second signals to one or more first user devices of the plurality of user devices to cause the user interface to identify locations of a first subset of the set of second ATMs; and
transmitting one or more third signals to one or more second user devices of the plurality of user devices to cause the user interface to identify locations of a second subset of the set of second ATMs.

15. The method of claim 10, comprising:
identifying, by the computing system based on a geographical region that includes the first ATM, one or more second ATMs of the plurality of ATMs proximate to the first ATM;
determining, by the computing system based on previous interactions with the one or more second ATMs, statuses of the one or more second ATMs, the statuses of the one or more second ATMs including predicted amounts of time to interact with the one or more second ATMs; and
transmitting, by the computing system, a second signal to the plurality of user devices to cause the user interface to identify the predicted amounts of time.

16. The method of claim 10, wherein the second status of the first ATM is a detection of a fault in a first authentication device of the first ATM, and comprising:
retrieving, by the computing system from the database, second information that identifies a plurality of authentication devices of the first ATM, the plurality of authentication devices including the first authentication device;
querying, by the computing system, the first ATM to provide third information corresponding to the plurality of authentication devices;
detecting, by the computing system based at least one the third information, one or more second authentication devices of the plurality of authentication devices available to authenticate one or more subsequent interactions; and
causing, by the computing system responsive to detection of the one or more second authentication devices, the first ATM to display a second user interface to identify the one or more second authentication devices.

17. The method of claim 10, wherein the second status of the first ATM includes at least one of:
an amount of resources falling below a first threshold;
a detection of a fault in an authentication device of the first ATM;
an amount of time to complete a first number of interactions with the first ATM exceeding a second threshold; or
a second number of interactions with the first ATM exceeding a third threshold.

18. A non-transitory computer-readable storage media having instructions stored thereon that, when executed by at least one processor of a computing system, cause the computing system to perform operations comprising:
monitoring, based on communications with a plurality of Automated Teller Machines (ATMs), a first plurality of interactions with the plurality of ATMs;
detecting, subsequent to monitoring the first plurality of interactions with the plurality of ATMs, a change from a first status of a first ATM of the plurality of ATMs to a second status of the first ATM;
retrieving, from a database, responsive to detection of the change from the first status to the second status, information corresponding to a second plurality of interactions with the first ATM;
identifying, responsive to retrieval of the information, one or more profiles associated with respective interactions of the second plurality of interactions;
determining, based at least one the one or more profiles, a plurality of user devices enrolled in a subscription to receive status updates regarding the first ATM; and
transmitting, responsive to determination of the plurality of user devices, a signal to the plurality of user devices to cause the plurality of user devices to display a user interface to identify the second status of the first ATM.

19. The non-transitory computer-readable storage media of claim 18, wherein the instructions, when executed by the at least one processor of the computing system, further cause the computing system to perform operations comprising:
identifying, by the computing system according to a geographical region that includes the first ATM, one or more second ATMs of the plurality of ATMs located within a predetermined proximity of the first ATM;
determining, by the computing system based at least on one or more interactions of the first plurality of interactions, statuses of the one or more second ATMs; and
transmitting, by the computing system responsive to determination of the statuses of the one or more second ATMs, a second signal to cause the user interface to identify the statuses of the one or more second ATMs.

20. The non-transitory computer-readable storage media of claim 18, wherein the second status of the first ATM includes at least one of:
an amount of resources falling below a first threshold;
a detection of a fault in an authentication device of the first ATM;
an amount of time to complete a first number of interactions with the first ATM exceeding a second threshold; or
a second number of interactions with the first ATM exceeding a third threshold.
